(19) United States
(12) Patent Application Publication
(10) Pub. No.: US 2026/0039624 A1
(43) Pub. Date: Feb. 5, 2026

(54) RECLAIMING ADDRESSES USED TO COMMUNICATE WITH MACHINES OVER A NETWORK

(71) Applicant: INTERNATIONAL BUSINESS MACHINES CORPORATION, ARMONK, NY (US)

(72) Inventors: Dinesh C. Verma, New Castle, NY (US); Bill Lambertson, High Falls, NY (US); SATISHKUMAR SADAGOPAN, Leawood, KS (US); Mathews Thomas, Flower Mound, TX (US); PAWAN RAGHUNATH CHOWDHARY, San Jose, CA (US); Gerald Coon, Durham, NC (US); Utpal Mangla, Toronto (CA)

(21) Appl. No.: 18/795,169

(22) Filed: Aug. 5, 2024

(51) Int. Cl. H04L 61/5046; H04L 61/251; H04L 61/4511; H04L 69/18; H04L 101/686

(52) U.S. Cl. CPC H04L 61/5046; H04L 61/251; H04L 61/4511; H04L 69/18; H04L 2101/686

(57) ABSTRACT

Provided are a computer program product, system, and method for reclaiming addresses used to communicate with machines over a network. A determination is made of a first machine using the first network protocol addressing scheme to communicate with a second machine over a network. A determination is made of whether the second machine supports a second network protocol addressing scheme. The first machine is configured to communicate with the second machine using the second network protocol addressing scheme to free a network address in the first network protocol addressing scheme used by the first machine to communicate with the second machine in response to determining that the second machine supports the second network protocol addressing scheme.

### BACKGROUND OF THE INVENTION

### 1. Field of the Invention

The present invention relates to a computer program product, system, and method for reclaiming addresses used to communicate with machines over a network.

### 2. Description of the Related Art

Internet Protocol version 4 (IPv4) network addresses were assigned to many companies in different sized blocks at the initial life-stage of the Internet. The address blocks were assigned in class A (16 million addresses per block/24 bits to address machines and 8 bits identifying the block), class B (65 thousand addresses per block/16 bits of address space for machines, and 16 bits identifying the block) or class C (256 addresses per block/8 bits to address machines and 24 bits to identify the block). A block of addresses is also referred to as a subnet. Many companies received a block of addresses greater than their needs for network addresses. With the definition of private and virtual address spaces, many companies do not need the IPv4 addresses they have been allocated. Further, with the release of IPV6 network addresses, of which there are a substantially greater number than allocatable IPv4 addresses, companies may seek to replace their IPv4 addresses with IPv6 addresses.

Many large cloud service providers are on an acquisition spree to acquire IPv4 addresses because most internet traffic is currently routed using IPv4 addresses. Current tools to identify unused IPv4 addresses available to transfer include IP address discovery tools that scan network tables, such as routing tables, Address Resolution Protocol (ARP) tables, etc. Some techniques ping IPv4 addresses to determine whether an IPv4 address is in use.

### SUMMARY

Provided are a computer program product, system, and method for reclaiming addresses used to communicate with machines over a network. A determination is made of a first machine using the first network protocol addressing scheme to communicate with a second machine over a network. A determination is made of whether the second machine supports a second network protocol addressing scheme. The first machine is configured to communicate with the second machine using the second network protocol addressing scheme to free a network address in the first network protocol addressing scheme used by the first machine to communicate with the second machine in response to determining that the second machine supports the second network protocol addressing scheme.

### BRIEF DESCRIPTION OF THE DRAWINGS

FIG. 1 illustrates an embodiment of a network environment in which IPv4 addresses are reclaimed.

FIG. 2 illustrates an embodiment of machine information indicating whether a local machine is communicating with external machines that support the IPv6 addressing scheme.

FIGS. 3A, 3B, and 3C illustrate an embodiment of operations to determine IPv4 addresses, used by local machines in an enterprise network that communicate with external machines, that may be reclaimed and replaced with IPv6 addresses.

FIG. 4 illustrates an embodiment of operations to reclaim IPv4 addresses used by local machines in the enterprise network.

FIG. 5 illustrates an embodiment of operations to reclaim IPv4 addresses in a subnet block of addresses that were not initially determined to be reclaimable.

FIG. 6 illustrates a computing environment in which the components of FIG. 1 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

### Example 1

A computer-implemented method for reclaiming network addresses in a first network protocol addressing scheme comprising determining a first machine using the first network protocol addressing scheme to communicate with a second machine over a network. The method further comprises determining whether the second machine supports a second network protocol addressing scheme. The method further comprises configuring the first machine to communicate with the second machine using the second network protocol addressing scheme to free a network address in the first network protocol addressing scheme used by the first machine to communicate with the second machine in response to determining that the second machine supports the second network protocol addressing scheme. Thus, embodiments advantageously allow for a determination of what addresses in a first network protocol addressing scheme are used to communicate with external machines that support a second network protocol addressing scheme. The determined network addresses may then be reclaimed and replaced with network addresses in the second network protocol addressing scheme.

### Example 2

The limitations of any of Examples 1 and 3-9, where the method further comprises that the first network protocol addressing scheme comprises the Internet Protocol version 4 addressing scheme and the second network protocol addressing scheme comprises the Internet Protocol version 6 addressing scheme. Thus, embodiments advantageously allow for reclamation of IPv4 addresses which are sought after by cloud service providers to use to provide cloud services to computers only supporting the IPv4 addressing scheme.

### Example 3

The limitations of any of Examples 1, 2, and 4-9, where the method further comprises that the first machine comprises a client machine and the second machine comprises a server accessed by the client machine over the network. The method further comprises that the determining whether the server supports the second network protocol addressing scheme comprises determining whether a domain name record for the server indicates a network address for the server using the second network protocol addressing scheme. The method further comprises that the server is determined to support the second network protocol addressing scheme in response to determining that the domain name record for the server indicates the server supports the second network protocol addressing scheme. Thus, embodiments advantageously allow for determining whether the server supports the second network protocol addressing scheme by examining domain name records, which may indicate that the server uses addresses in the second network protocol addressing scheme.

### Example 4

The limitations of any of Examples 1-3 and 5-9, where the method further comprises that the first machine comprises a client machine and the second machine comprises a server accessed by the client machine over the network. The method further comprises that the determining whether the server supports the second network protocol addressing scheme comprises processing a log of communications to the server to determine whether different server aliases are used to communicate with the server. The method further comprises determining whether the second network protocol addressing scheme is used to communicate with one of the server aliases for the server. The method further comprises that the server is determined to support the second network protocol addressing scheme in response to determining that the second network protocol addressing scheme is used to communicate with one of the server aliases. Thus, embodiments advantageously consider server alias names when multiple server names are used to access an external server from within a network, because even if one of the server names does not support the second network protocol addressing scheme other of the alias addresses may support the second network protocol addressing scheme to allow for reclamation of the first network protocol addressing scheme addresses from the client.

### Example 5

The limitations of any of Examples 1˜4 and 6-9, where the method further comprises that the first machine comprises a server and the second machine comprises a client communicating with the server over the network. The method further comprises that the determining whether the client supports the second network protocol addressing scheme comprises receiving a request from the client to access the server using the first network protocol addressing scheme. The method further comprises returning a response to the request to the client to redirect the client to access an alternate server using a network address in the second network protocol addressing scheme. The method further comprises determining whether the client accessed the alternate server using the second network protocol addressing scheme in response to the redirect in the returned response. The client is determined to support the second network protocol addressing scheme in response to determining that the client accessed the alternate server using the second network protocol addressing scheme. Thus, embodiments advantageously send a redirect request to the external client to communicate with an alternate server only supporting the second network protocol addressing scheme, which confirms that the external client supports the second network protocol addressing scheme to allow the first network protocol addresses to be reclaimed from the server because the external client can communicate using the second network protocol addressing scheme.

### Example 6

The limitations of any of Examples 1-5 and 7-9, where the method further comprises that the first machine comprises a server and the second machine comprises a client communicating with the server over the network. The method further comprises that the determining whether the client supports the second network protocol addressing scheme comprises receiving a request from the client to access the server using the first network protocol addressing scheme. The method further comprises determining whether the client accesses an alternate server using the second network protocol addressing scheme. In this way, the client is determined to support the second network protocol addressing scheme in response to determining that the client accessed the alternate server using the second network protocol addressing scheme. Thus, embodiments advantageously determine whether the external client communicates with an alternate server only supporting the second network protocol addressing scheme, which confirms that the external client supports the second network protocol addressing scheme to allow the first network protocol addresses to be reclaimed from the server because the client can communicate using the second network protocol addressing scheme.

### Example 7

The limitations of any of Examples 1-6, 8, and 9, where the method further comprises that that the operations of the determining the first machine, determining whether the second machine supports the second network protocol addressing scheme, and the configuring the first machine are performed for a plurality of a first set of machines in a first network that communicate with a second set of machines over the network comprising a second network. The method further comprises that the operations performed for the first set of machines further comprise indicating network addresses in the first network protocol addressing scheme used by the first set of machines that communicate with the second set of machines that support the second network protocol addressing scheme in a reclamation list. The method further comprises processing the reclamation list to configure the machines in the first set of machines having network addresses indicated in the reclamation list to communicate with the second set of machines using the second network protocol addressing scheme to transfer ownership of the network addresses indicated in the reclamation list to a third party. Thus, embodiments advantageously allows for reclamation of the first network protocol addresses from a first set of machines in a first network by determining whether the second set of machines with which they communicate support the second network protocol addressing scheme to allow reclamation of addresses in the first network protocol addressing scheme from an entire network, increasing the reclamation.

### Example 8

The limitations of any of Examples 1-7 and 9, where the method further comprises that the operations of the determining the first machine, determining whether the second machine supports the second network protocol addressing scheme, and the configuring the first machine are performed for a first set of machines in a first network that communicate with a second set of machines over the network comprising a second network. The method further comprises that the operations performed for the first set of machines further comprise indicating network addresses in the first network protocol addressing scheme used by the first set of machines that communicate with the second set of machines that support the second network protocol addressing scheme in a reclamation list. The method further comprises determining whether all addresses in a block of addresses in a subnet of network addresses in the first network protocol addressing scheme are indicated in the reclamation list. The method further comprises indicating the subnet of network addresses in the first network protocol addressing scheme as available for transfer to a third party. Thus, embodiments advantageously allow for reclamation of an entire subnet of network addresses in the first network protocol addressing scheme, where transferring an entire subnet of reclaimed first network protocol addresses has the most value to third parties acquiring network addresses in the first network protocol addressing scheme.

### Example 9

The limitations of any of Examples 1-8, where the method further comprises determining an owner of a specified machine of the second set of machines communicating with one of the first set of machines using a network address in the subnet of network addresses not in the reclamation list. The method further comprises determining a value of the owner of the specified machine to an operator of the first set of machines. The method further comprises adding the network address of one of the first set of machines communicating with the specified machine to the reclamation list in response to determining that the value of the owner to the operator of the first set of machines is below a threshold value. The subnet of network addresses is indicated as available for transfer in response to adding all network addresses in the subnet of network addresses to the reclamation list that were determined to not be in the reclamation list in response to determining that values of owners are below the threshold value. Thus, embodiments advantageously allow reclamation of network addresses in the first network protocol addressing scheme when the external machine with which the network addresses are used does not support the second network protocol addressing scheme. Embodiments advantageously determine if the external machine is owned by an owner not providing sufficient value such that it is worthwhile to termination communication with the external machine in order to reclaim the network address in the first network protocol addressing scheme used to communicate with the external machine.

Example 10 is an apparatus comprising means to perform a method of any of the Examples 1-9.

Example 11 is a machine-readable storage including machine-readable instructions, when executed, to implement a method or realize an apparatus of any of the Examples 1-9.

### Example 12

A system comprising one or more processor and one or more computer-readable storage media collectively storing program instructions which, when executed by the processor, are configured to cause the processor to perform a method according to any of Examples 1-9.

### Example 13

A computer program product comprising one or more computer readable storage media, and program instructions collectively stored on the one or more computer readable storage media, the program instructions comprising instructions configured to cause one or more processors to perform a method according to any one of Examples 1-9.

Current techniques seek to identify IPv4 addresses to reclaim by discovering local machine addresses that are unused. However, such techniques are limited in that they do not identify local IPv4 addresses that are in use to communicate with external machines that may nonetheless be reclaimed and replaced with IPv6 addresses without disrupting communication with the external machines. A local or internal machine is defined as a machine whose administrative control is with the organization owning the block of IPV4 addresses. An external machine comprises a machine that is not under the administrative control of the organization owning the block of IPV4 addresses and that communicates with one or more local machines over the Internet or another network. An external machine can act either as a client or as a server when communicating with an internal machine. The challenge is to discover which external machines can successfully switch to using IPv6 addresses. A machine can switch over to IPv6 communication if the external machine supports the IPv6 protocol and has a path to the local machine that can support IPv6. If those external machines are discovered, then local machines communicating with them can be switched over to IPv6 and the local machines' IPv4 addresses can be reclaimed.

Described embodiments provide improved computer technology to identify which external clients or servers, communicating with a local machine using an IPv4 address, can support the IPV6 addressing scheme. Once the external machines supporting the IPV6 addressing scheme are identified, then the IPV4 addresses, used by the local machines to communicate with such external machines 112ᵢ, can be reclaimed. The local machines may then be reconfigured to use IPv6 addresses, because such external machines were identified as supporting the IPv6 addressing scheme.

Described embodiments further provide techniques to determine if an IPV4 address can be reclaimed from a local machine when the external machine does not support IPv6 by determining whether disconnecting from the external machine will not be to a detriment to the enterprise.

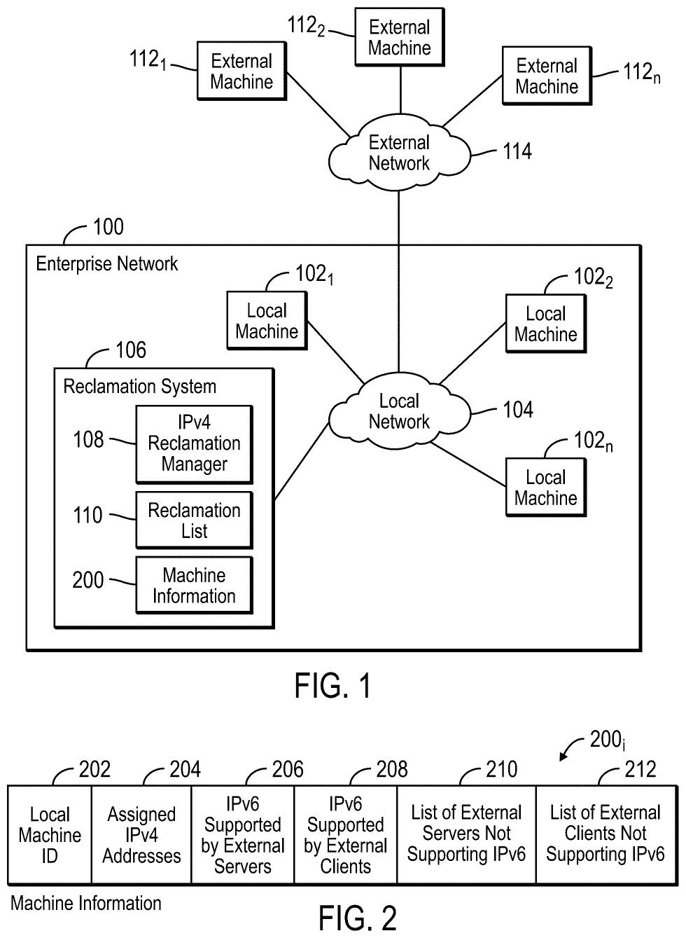

FIG. 1 illustrates an embodiment of a network computing environment comprised of an enterprise network 100 having a plurality of local machines 102₁, 102₂ . . . 102ₙ communicating over a local network 104 and a reclamation system 106 including programs to reclaim IPv4 addresses used by the local machines 102₁, 102₂ . . . 102ₙ. The reclamation system 106 may include an IPv4 reclamation manager 108, a reclamation list 110 of IPv4 addresses used by the local machines 102ᵢ that may be reclaimed and transferred to a third party, and machine information 200 on the local machines 102₁, 102₂ . . . 102ₙ, including indication of whether external machines 112₁, 112₂ . . . 112ₙ, with which the local machines 102₁, 102₂ . . . 102ₙ communicate over a network 114, support an IPv6 addressing scheme. A local machine 102ᵢ may function as a client machine communicating with an external machine 112ᵢ functioning as an external server and/or the local machine 102ᵢ may function as a server communicating with an external machine 112ᵢ functioning as an external client. Thus, a local machine 102ᵢ may function as a client and/or a server with respect to the external machines 112ᵢ.

The reclamation manager 108 determines whether local machines 102ᵢ using an IPv4 addressing scheme communicate with external machines 112ᵢ that support the IPV6 addressing scheme. If an external machine 112ᵢ supports the IPv6 addressing scheme, then the IPV4 address used by the local machine 102ᵢ communicating with that external machine 112ᵢ may be added to the reclamation list 110 indicating that that IPv4 address is available to be transferred to a third party.

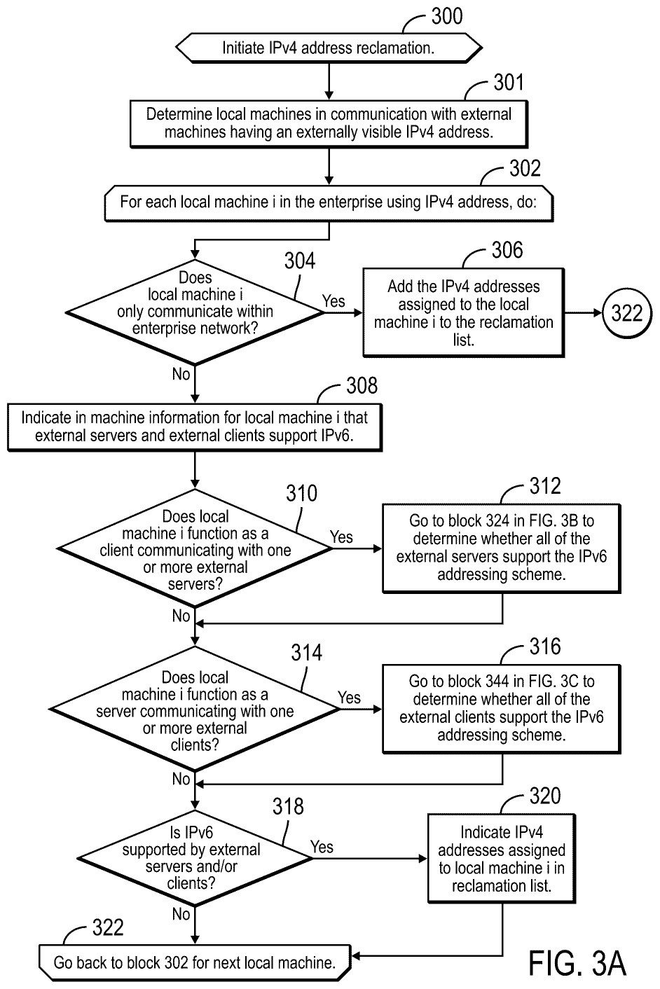

The reclamation manager 108 may generate a machine information instance 200ᵢ, as shown in FIG. 2, having information for a local machine 102ᵢ, including a local machine Identifier (ID) 202 for the local machine 102ᵢ; assigned IPv4 addresses 204 for the local machine 202ᵢ indication 206 of whether IPv6 is supported by external servers 112ᵢ to which the local machine connects 202ᵢ indication 208 of whether IPv6 is supported by external clients 112ᵢ with which the local machine 202 connects; a list 210 of external servers 112ᵢ not supporting IPv6 to which the local machine 202 connects; and a list 212 of external clients 112ᵢ not supporting IPv6 to which the local machine 202 connects.

In certain embodiments, the local network 104 may only be accessible to devices within the enterprise network 100, and comprise a local area network (LAN), storage area network (SAN), intranet, etc. The external network 114 may comprise the internet or another network through which the external machines 112ᵢ connect.

The local 102ᵢ and external machines 112ᵢ may comprise physical or virtual computer systems. The machines 102ᵢ and 112ᵢ may comprise servers, client machines, desktop computers, laptops, smartphones, tablet computers, wearable computers, etc.

The reference to machines and networks as local and external is for illustrative purposes, and the local machines 102ᵢ may comprise any grouping of a first set of machines and the external machines 112ᵢ may comprise any grouping of a second set of machines, such that the first set of machines communicate over a first network with each other and communicate with the second set of machines over a second network.

In FIG. 1, the network 100 is shown as an enterprise network. In alternative embodiments, the network may comprise other types of networks than enterprise networks.

The IPv4 reclamation manager 108 may comprise program code loaded into a memory and executed by one or more processors. Alternatively, some or all of the functions may be implemented as microcode or firmware in hardware devices, such as in Application Specific Integrated Circuits (ASICs), Field Programmable Gate Array (FPGA).

In the described embodiments, the reclamation manager 108 seeks to reclaim IPv4 addresses from local machines 102ᵢ to replace with IPv6 addresses when the local machines 102ᵢ interact with external machines 112ᵢ that support IPv6. In alternative embodiments, network protocol addressing schemes other than IPv4 and IPv6 may be involved, where the reclaimed addresses may be part of a first network protocol addressing scheme and the new addresses replacing the reclaimed addresses may be part of a second network protocol addressing scheme. In this way, described embodiments are not limited to the IPV4 and IPV6 addressing schemes.

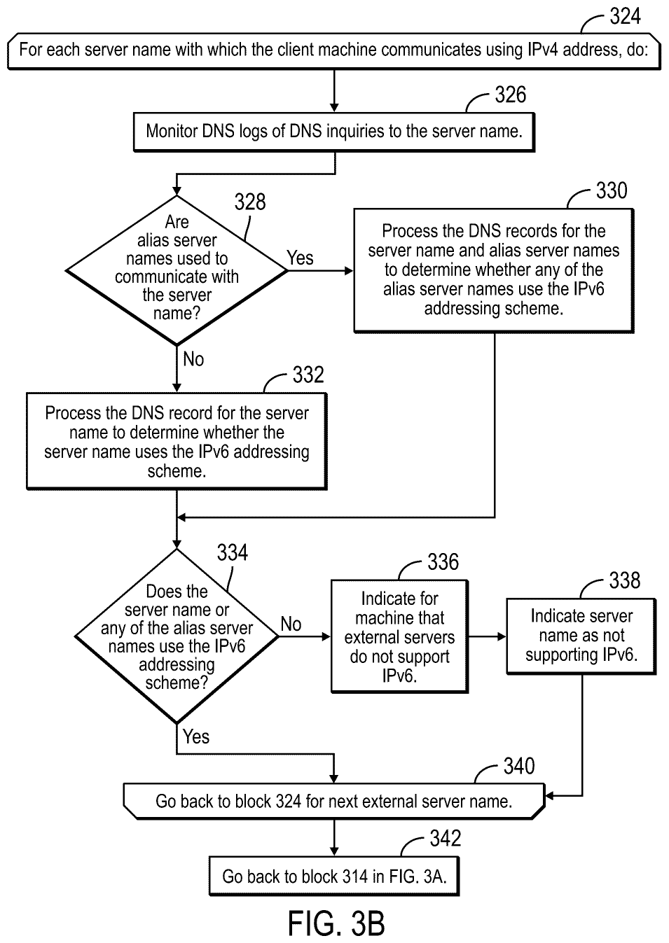

FIGS. 3A, 3B, 3C comprise operations performed by the reclamation manager 108 to reclaim IPv4 addresses, or addresses in a first network protocol addressing scheme, from the local machines 102ᵢ to transfer to a third party and replace with IPv6 addresses, or addresses in a second network protocol addressing scheme. Upon initiating (at block 300) IPv4 address reclamation, a determination is made (at block 301) of local machines 102ᵢ having an externally visible IPv4 address in communication with external machines 112ᵢ. This determination can be performed by collecting the source and destination IP addresses of the machines captured at firewalls in the enterprise network 100. Alternatively, if the enterprise communication comprises servers 102ᵢ, e.g. web-sites or web-services providers, the logs of the web-sites/web-servers would include the identity of the external clients 112ᵢ communicating with the local servers, and the externally visible IPv4 addresses of the local servers 102ᵢ can be collected from the logs.

After identifying local machines 102ᵢ using IPv4 addresses to communicate with external machines 112ᵢ, a loop of operations is performed at blocks 302 through 322 for each of the local machines 102ᵢ in the enterprise network 100 using the IPv4 addressing scheme. If (at block 304) local machine 102ᵢ only communicates with other local machines 102ⱼ in the local network 104 and do not communicate with external machines 112ᵢ, then the IPv4 addresses assigned to the local machine 102ᵢ are added to the reclamation list 110.

If (at block 304) the local machine 102ᵢ communicates with external machines 102ᵢ, then, as a default setting, the fields 206 and 208 in the machine information 200ᵢ for local machine 102ᵢ indicate that IPv6 is supported by external servers and external clients, respectively, with which local machine 102ᵢ communicates, to signal that the IPV4 addresses 204 may be reclaimed. If (at block 310) the local machine 102ᵢ functions as a client communicating with one or more external servers 112ᵢ, control proceeds (at block 312) to block 324 in FIG. 3B where a loop of operations is performed at blocks 324 to 340 for each server 112ᵢ name with which the client machine 102ᵢ communicates. The reclamation manager 108 monitors (at block 326) DNS logs of DNS inquiries to the server name.

If (at block 328) there are alias server names used to communicate with the server name of server 112ᵢ, then the reclamation manager 108 processes (at block 330) the DNS records for the server name and alias server names to determine whether any of the server name and the alias server names use the IPV6 addressing scheme. If (at block 328) alias server names are not used, then the reclamation manager 108 processes (at block 332) the DNS records for the server name to determine whether the server name uses the IPv6 addressing scheme. From blocks 330 or 332, if (at block 334) the server name or any of the alias server names do not use the IPV6 addressing scheme, field 206 is set (at block 336) to indicate that IPv6 is not supported by external servers and the server name is indicated (at block 338) in the list 210 of external servers not supporting IPv6. From block 338 or if (at block 334) the server name or any of the alias server names do support the IPV6 addressing scheme, then control proceeds (at block 340) back to block 324 to consider a next external server 112ᵢ with which client 102ᵢ communicates. After considering all external servers 112ᵢ with which client 102ᵢ communicates (at block 340) or if (at block 310) the local machine 102ᵢ does not function as a client machine, control proceeds to block 314 in FIG. 3A to determine whether the local machine 102ᵢ functions as a server communicating with one or more external clients 112ᵢ. If (at block 314) the local machine 102ᵢ functions as a server machine to one or more external clients 112ᵢ, then control proceeds (at block 316) to block 344 in FIG. 3C to determine whether all of the external clients 112ᵢ support the IPV6 addressing scheme.

At block 344 in FIG. 3C, for each external client 112ᵢ with which the local server 102ᵢ communicates using IPv4 address scheme, the reclamation manager 108 instructs the external client 112ᵢ to send a redirect request to the external client to access an image from an alternate server in the enterprise network 100 only supporting IPv6 in response to a request from the external client 112ᵢ. The image may comprise a one pixel image and the alternate server may comprise a virtual machine, container or physical machine, only supporting IPV6. For instance, the server 112ᵢ may support REST (representational state transfer) and HTTP (hypertext transport protocol), to allow for a redirect to another URL of the alternate server using REST. After a period of time, the reclamation manager 110 may process (at block 346) the IP logs to determine whether the external clients 112ᵢ communicated with the alternate server using IPV6. If (at 348) not all external clients 112ᵢ communicated with the alternate server using IPv6, then indication is made (at block 350), in field 208 of the machine information 200ᵢ for server 102ᵢ, that IPv6 is not supported by external clients 112ᵢ. External clients 112ᵢ that did not communicate with the alternate server using IPv6 are indicated (at block 352) in the list 212 of external clients not supporting IPv6. From the yes branch of block 348 or from block 352 control proceeds (at block 354) back to block 318 in FIG. 3A.

At block 318 in FIG. 3A, if fields 206 and 208 indicate that IPv6 is supported by external servers and/or clients, then the IPV4 addresses 204 assigned to the local machine 102ᵢ are indicated (at block 320) in the reclamation list 110. If (at block 318) fields 206 and/or 208 indicate that IPv6 is not supported by external servers and/or clients, then the IPv4 addresses for machine 102ᵢ are not added to the reclamation list 110. From the NO branch of block 318 or from block 320, control proceeds (at block 322) back to block 302 to consider the next local machine 102ᵢ in the enterprise network 100 until all local machines 102ᵢ using the IPv4 addressing scheme are considered.

With the embodiments of FIGS. 3A, 3B, and 3C, the reclamation manager 108 determines whether external machines with which local machines using IPv4 addresses interact support the IPv6 protocol. To make such a determination for external clients, the reclamation manager 108 causes the external client 112ᵢ to communicate directly with an alternate server supporting only IPv6 to ensure that the external client 112ᵢ in fact supports IPv6. The reclamation manager 108 may not be able to rely on domain records because even if the external client 112ᵢ supported IPv6, it may communicate through an Internet Service Provider (ISP) or router that only supports IPv4, which limits that external client 112ᵢ to using only the IPv4 addressing scheme even when it supports IPv6. For this reason, the reclamation manager 108 causes the external client to communicate directly using IPv6 to ensure that external client in fact uses IPV6. Further, when the external machine 112ᵢ comprises a server, the reclamation manager 108 looks at alias server names for the external server because local machines may use different aliases server names to communicate with the server, such as if the server is part of a content distribution network (CDN) comprising a geographically distributed network of proxy servers. In such case, the reclamation manager 108 can determine that the external server supports IPv6 if any alias server name or the server name supports IPv6. Once the reclamation manager 108 is ensured that the external machine supports IPv6, then the IPv4 used by the local machine communicating with that external machine may be reclaimed and the local machine configured to use an IPV6 address.

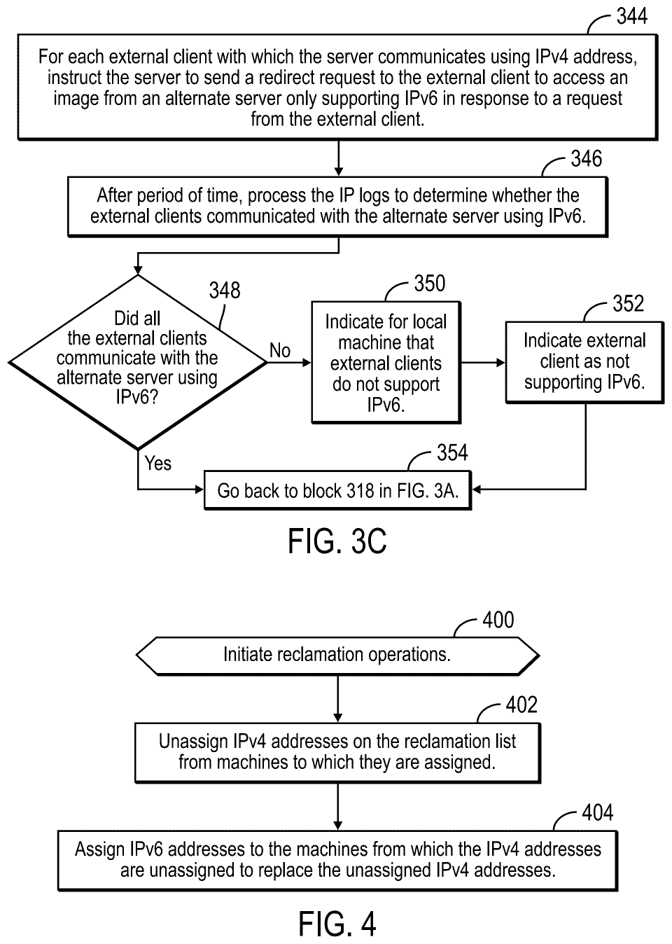

FIG. 4 illustrates an embodiment of operations performed by the reclamation manager 108 or another component to process the reclamation list 110 to determine IPv4 addresses that can be reclaimed. Upon initiating (at block 400) the reclamation operations, the reclamation manager 108 unassigns (at block 402) IPv4 addresses on the reclamation list 108 from machines 102ᵢ to which they are assigned. IPv6 addresses are then assigned (at block 404) to the machines 102ᵢ from which the IPv4 addresses are unassigned to replace the unassigned IPv4 addresses with the IPV6 addresses. After the IPv4 addresses are unassigned they may then be transferred or sold to a third party.

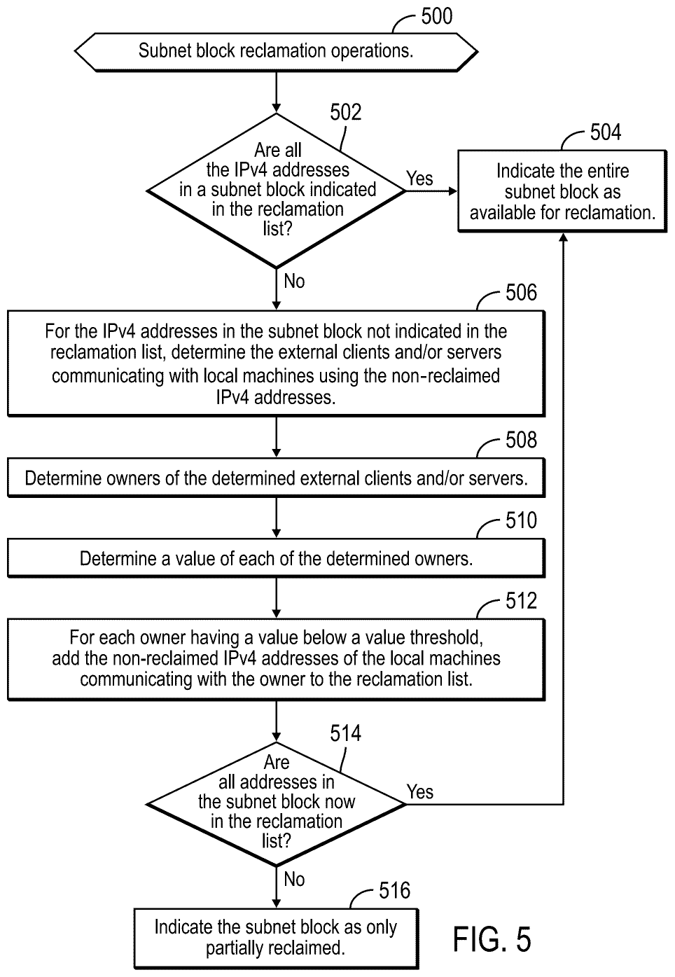

FIG. 5 illustrates an embodiment of operations performed by the reclamation manager 108 to aggressively reclaim all IPv4 addresses in a subnet block of network addresses, even if all the IPV4 addresses in the subnet block are not indicated in the reclamation list according to the operations of FIGS. 3A, 3B, 3C. A reclaimed entire subnet block of network IPv4 addresses is considerably more valuable than an incomplete subnet block because those entities acquiring IPv4 addresses prefer to acquire an entire block of IPv4 addresses. Upon initiating (at block 500) subnet block reclamation operations, if (at block 502) all the IPV4 addresses in a subnet block are indicated in the reclamation list 110, then the entire subnet block is indicated as available for reclamation so that the entire subnet block of IPV4 addresses may be transferred. If (at block 502) all the IPV4 addresses in a subnet block are not indicated in the reclamation list 110, according to the operations of FIGS. 3A, 3B, and 3C, then for the IPV4 addresses in the subnet block not indicated in the reclamation list, a determination is made (at block 506) of the external clients and/or servers 112ᵢ communicating with local machines 102ᵢ using the non-reclaimed IPv4 addresses. These determined external clients and/or servers 112ᵢ would not support the IPV6 addressing scheme. The list of external machines 112ᵢ not supporting IPv6 may be determined from fields 210 and 212 in the machine information 200ᵢ for local machines 102ᵢ that indicates IPv6 is not supported for external servers 206 or clients 208.

The reclamation manager 110 may then determine (at block 508) owners of the determined external clients and/or servers 112ᵢ that do not support IPv6. The owners may be determined from an internal database or DNS records. The reclamation manager 110 may then process specific internal enterprise databases to determine (at block 510) a value of each of the determined owners of the external machines 112ᵢ not supporting IPv6. The determined value may be based on an economic value, such as business conducted with the owner, or a non-economic value, such as an important non-economic relationship between the enterprise and the owner. For each owner having a value below a value threshold, i.e., not an important owner to the enterprise, the non-reclaimed IPv4 addresses of the local machines communicating with the external machines, having owners with a low value to the enterprise, are added (at block 512) to the reclamation list 110. If (at block 514) all the addresses in the subnet block are now in the reclamation list 110, then the subnet block is indicated (at block 504) as available for reclamation as a whole. If (at block 514) all the addresses in the subnet block are still not in the reclamation list 110, then the subnet block is indicated (at block 516) as only partially reclaimed.

With the embodiment of FIG. 5, the reclamation manager 108 makes determinations to reclaim IPv4 addresses for local machines communicating with external machines not supporting IPv6, which will result in terminating communication with those external machines. The reclamation manager 108 may determine the economic or non-economic cost of terminating communication with those external machines not supporting IPv4 addresses to determine whether the benefits of being able to reclaim an entire subnet block for an enhanced price exceeds the importance of the owners whose external machines will be cut-off from the enterprise. For instance, if the owners of the external machines that will be disconnected from the enterprise conduct substantial business with the enterprise, then the financial benefit of reclaiming an entire subnet block may not outweigh the loss of business from such owners. However, if the owners of those machines make insignificant contributions to the economic or subjective benefit of the enterprise, then the IPv4 addresses used to communicate with those external machines may be reclaimed.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

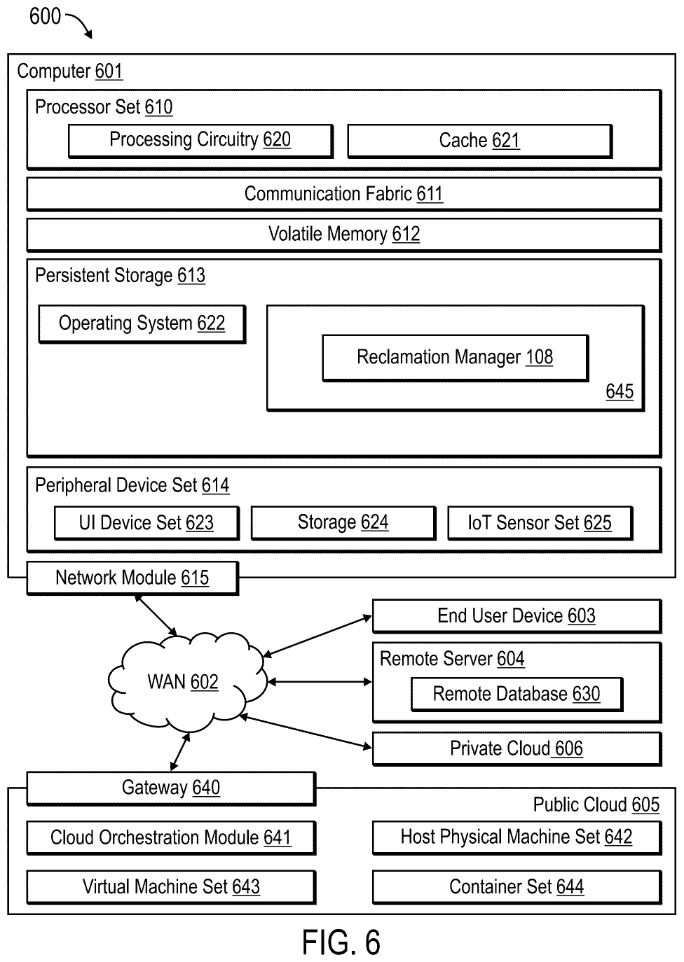

With respect to FIG. 6, computing environment 600 contains an example of an environment for the execution of at least some of the computer code involved in performing the inventive methods, such as the reclamation manager 106 in block 645, to reclaim IPv4 addresses used by local machines that interact with external machines that support the IPV6 addressing scheme. In addition to block 645, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 645, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface-type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on. In certain embodiments, the EUD 603 may comprise the external machines 112ᵢ functioning as clients to local machines 102ᵢ functioning as servers, as described with respect to FIG. 1.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. In certain embodiments, the remote server 604 may comprise external machines 112ᵢ functioning as servers to local machines 102ᵢ functioning as clients, as described with respect to FIG. 1.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602. In certain embodiments, the external network 114 may comprise a public cloud 605.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud. The enterprise network 100 and local machines 102ᵢ therein, as described with respect to FIG. 1, may comprise a private cloud 606.

CLOUD COMPUTING SERVICES AND/OR MICROSERVICES (not separately shown in FIG. 6): private and public clouds 606 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, j, n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for reclaiming network addresses in a first network protocol addressing scheme, the computer program product comprising a computer readable storage medium having computer readable program code embodied therein that when executed performs operations, the operations comprising:
determining a first machine using the first network protocol addressing scheme to communicate with a second machine over a network;
determining whether the second machine supports a second network protocol addressing scheme; and
configuring the first machine to communicate with the second machine using the second network protocol addressing scheme to free a network address in the first network protocol addressing scheme used by the first machine to communicate with the second machine in response to determining that the second machine supports the second network protocol addressing scheme.

2. The computer program product of claim 1, wherein the first network protocol addressing scheme comprises the Internet Protocol version 4 addressing scheme and wherein the second network protocol addressing scheme comprises the Internet Protocol version 6 addressing scheme.

3. The computer program product of claim 1, wherein the first machine comprises a client machine and the second machine comprises a server accessed by the client machine over the network, wherein the determining whether the server supports the second network protocol addressing scheme comprises:
determining whether a domain name record for the server indicates a network address for the server using the second network protocol addressing scheme, wherein the server is determined to support the second network protocol addressing scheme in response to determining that the domain name record for the server indicates the server supports the second network protocol addressing scheme.

4. The computer program product of claim 1, wherein the first machine comprises a client machine and the second machine comprises a server accessed by the client machine over the network, wherein the determining whether the server supports the second network protocol addressing scheme comprises:
processing a log of communications to the server to determine whether different server aliases are used to communicate with the server; and
determining whether the second network protocol addressing scheme is used to communicate with one of the server aliases for the server, wherein the server is determined to support the second network protocol addressing scheme in response to determining that the second network protocol addressing scheme is used to communicate with one of the server aliases.

5. The computer program product of claim 1, wherein the first machine comprises a server and the second machine comprises a client communicating with the server over the network, wherein the determining whether the client supports the second network protocol addressing scheme comprises:
receiving a request from the client to access the server using the first network protocol addressing scheme;
returning a response to the request to the client to redirect the client to access an alternate server using a network address in the second network protocol addressing scheme; and
determining whether the client accessed the alternate server using the second network protocol addressing scheme in response to the redirect in the returned response, wherein the client is determined to support the second network protocol addressing scheme in response to determining that the client accessed the alternate server using the second network protocol addressing scheme.

6. The computer program product of claim 1, wherein the first machine comprises a server and the second machine comprises a client communicating with the server over the network, wherein the determining whether the client supports the second network protocol addressing scheme comprises:
receiving a request from the client to access the server using the first network protocol addressing scheme; and
determining whether the client accesses an alternate server using the second network protocol addressing scheme, wherein the client is determined to support the second network protocol addressing scheme in response to determining that the client accessed the alternate server using the second network protocol addressing scheme.

7. The computer program product of claim 1, wherein the operations of the determining the first machine, determining whether the second machine supports the second network protocol addressing scheme, and the configuring the first machine are performed for a plurality of a first set of machines in a first network that communicate with a second set of machines over the network comprising a second network, wherein the operations performed for the first set of machines further comprise:
indicating network addresses in the first network protocol addressing scheme used by the first set of machines that communicate with the second set of machines that support the second network protocol addressing scheme in a reclamation list; and
processing the reclamation list to configure the machines in the first set of machines having network addresses indicated in the reclamation list to communicate with the second set of machines using the second network protocol addressing scheme to transfer ownership of the network addresses indicated in the reclamation list to a third party.

8. The computer program product of claim 1, wherein the operations of the determining the first machine, determining whether the second machine supports the second network protocol addressing scheme, and the configuring the first machine are performed for a first set of machines in a first network that communicate with a second set of machines over the network comprising a second network, wherein the operations performed for the first set of machines further comprise:
indicating network addresses in the first network protocol addressing scheme used by the first set of machines that communicate with the second set of machines that support the second network protocol addressing scheme in a reclamation list;
determining whether all addresses in a block of addresses in a subnet of network addresses in the first network protocol addressing scheme are indicated in the reclamation list; and
indicating the subnet of network addresses in the first network protocol addressing scheme as available for transfer to a third party.

9. The computer program product of claim 8, wherein the operations further comprises:
determining an owner of a specified machine of the second set of machines communicating with one of the first set of machines using a network address in the subnet of network addresses not in the reclamation list;
determining a value of the owner of the specified machine to an operator of the first set of machines; and
adding the network address of one of the first set of machines communicating with the specified machine to the reclamation list in response to determining that the value of the owner to the operator of the first set of machines is below a threshold value, wherein the subnet of network addresses is indicated as available for transfer in response to adding all network addresses in the subnet of network addresses to the reclamation list that were determined to not be in the reclamation list in response to determining that values of owners are below the threshold value.

10. A system for reclaiming network addresses in a first network protocol addressing scheme, comprising:
a processor; and
a computer readable storage medium having computer readable program code embodied therein that when executed performs operations, the operations further comprising:
determining a first machine using the first network protocol addressing scheme to communicate with a second machine over a network;
determining whether the second machine supports a second network protocol addressing scheme; and
configuring the first machine to communicate with the second machine using the second network protocol addressing scheme to free a network address in the first network protocol addressing scheme used by the first machine to communicate with the second machine in response to determining that the second machine supports the second network protocol addressing scheme.

11. The system of claim 10, wherein the first machine comprises a client machine and the second machine comprises a server accessed by the client machine over the network, wherein the determining whether the server supports the second network protocol addressing scheme comprises:
determining whether a domain name record for the server indicates a network address for the server using the second network protocol addressing scheme, wherein the server is determined to support the second network protocol addressing scheme in response to determining that the domain name record for the server indicates the server supports the second network protocol addressing scheme.

12. The system of claim 10, wherein the first machine comprises a client machine and the second machine comprises a server accessed by the client machine over the network, wherein the determining whether the server supports the second network protocol addressing scheme comprises:
processing a log of communications to the server to determine whether different server aliases are used to communicate with the server; and
determining whether the second network protocol addressing scheme is used to communicate with one of the server aliases for the server, wherein the server is determined to support the second network protocol addressing scheme in response to determining that the second network protocol addressing scheme is used to communicate with one of the server aliases.

13. The system of claim 10, wherein the first machine comprises a server and the second machine comprises a client communicating with the server over the network, wherein the determining whether the client supports the second network protocol addressing scheme comprises:
receiving a request from the client to access the server using the first network protocol addressing scheme; and
determining whether the client accesses an alternate server using the second network protocol addressing scheme, wherein the client is determined to support the second network protocol addressing scheme in response to determining that the client accessed the alternate server using the second network protocol addressing scheme.

14. The system of claim 10, wherein the operations of the determining the first machine, determining whether the second machine supports the second network protocol addressing scheme, and the configuring the first machine are performed for a first set of machines in a first network that communicate with a second set of machines over the network comprising a second network, wherein the operations performed for the first set of machines further comprise:
indicating network addresses in the first network protocol addressing scheme used by the first set of machines that communicate with the second set of machines that support the second network protocol addressing scheme in a reclamation list;
determining whether all addresses in a block of addresses in a subnet of network addresses in the first network protocol addressing scheme are indicated in the reclamation list; and
indicating the subnet of network addresses in the first network protocol addressing scheme as available for transfer to a third party.

15. The system of claim 14, wherein the operations further comprises:
determining an owner of a specified machine of the second set of machines communicating with one of the first set of machines using a network address in the subnet of network addresses not in the reclamation list;
determining a value of the owner of the specified machine to an operator of the first set of machines; and
adding the network address of one of the first set of machines communicating with the specified machine to the reclamation list in response to determining that the value of the owner to the operator of the first set of machines is below a threshold value, wherein the subnet of network addresses is indicated as available for transfer in response to adding all network addresses in the subnet of network addresses to the reclamation list that were determined to not be in the reclamation list in response to determining that values of owners are below the threshold value.

16. A computer implemented method for reclaiming network addresses in a first network protocol addressing scheme, comprising:
determining a first machine using the first network protocol addressing scheme to communicate with a second machine over a network;
determining whether the second machine supports a second network protocol addressing scheme; and
configuring the first machine to communicate with the second machine using the second network protocol addressing scheme to free a network address in the first network protocol addressing scheme used by the first machine to communicate with the second machine in response to determining that the second machine supports the second network protocol addressing scheme.

17. The method of claim 16, wherein the first machine comprises a client machine and the second machine comprises a server accessed by the client machine over the network, wherein the determining whether the server supports the second network protocol addressing scheme comprises:
determining whether a domain name record for the server indicates a network address for the server using the second network protocol addressing scheme, wherein the server is determined to support the second network protocol addressing scheme in response to determining that the domain name record for the server indicates the server supports the second network protocol addressing scheme.

18. The method of claim 16, wherein the first machine comprises a client machine and the second machine comprises a server accessed by the client machine over the network, wherein the determining whether the server supports the second network protocol addressing scheme comprises:
processing a log of communications to the server to determine whether different server aliases are used to communicate with the server; and
determining whether the second network protocol addressing scheme is used to communicate with one of the server aliases for the server, wherein the server is determined to support the second network protocol addressing scheme in response to determining that the second network protocol addressing scheme is used to communicate with one of the server aliases.

19. The method of claim 16, wherein the first machine comprises a server and the second machine comprises a client communicating with the server over the network, wherein the determining whether the client supports the second network protocol addressing scheme comprises:
receiving a request from the client to access the server using the first network protocol addressing scheme; and
determining whether the client accesses an alternate server using the second network protocol addressing scheme, wherein the client is determined to support the second network protocol addressing scheme in response to determining that the client accessed the alternate server using the second network protocol addressing scheme.

20. The method of claim 16, wherein the operations of the determining the first machine, determining whether the second machine supports the second network protocol addressing scheme, and the configuring the first machine are performed for a first set of machines in a first network that communicate with a second set of machines over the network comprising a second network, wherein the operations performed for the first set of machines further comprise:
indicating network addresses in the first network protocol addressing scheme used by the first set of machines that communicate with the second set of machines that support the second network protocol addressing scheme in a reclamation list;
determining whether all addresses in a block of addresses in a subnet of network addresses in the first network protocol addressing scheme are indicated in the reclamation list; and
indicating the subnet of network addresses in the first network protocol addressing scheme as available for transfer to a third party.
